(19) United States
(12) Patent Application Publication
(10) Pub. No.: US 2015/0237003 A1
(43) Pub. Date: Aug. 20, 2015

(54) COMPUTERIZED TECHNIQUES FOR NETWORK ADDRESS ASSIGNMENT

(71) Applicant: Benu Networks, Inc., Billerica, MA (US)

(72) Inventors: Rajat GHAI, Sandwich, MA (US); Swarup SAHOO, Acton, MA (US)

(21) Appl. No.: 14/625,447

(22) Filed: Feb. 18, 2015

Related U.S. Application Data
(60) Provisional application No. 61/941,106, filed on Feb. 18, 2014.

(51) Int. Cl. H04L 29/12

(52) U.S. Cl. CPC H04L 61/2015; H04L 61/2503; H04L 61/203

(57) ABSTRACT

Computer-implemented systems, methods, and computer-readable media are provided for assigning an IP address to a client device through an authentication process without needing to receive a dynamic host configuration protocol (DHCP) discover message to trigger the authentication process. In accordance with some embodiments, a message requesting assignment of an IP address to the client device is received, and a determination is made that identification information for the client device is not stored in a storage device. A request for authentication of the client device is then sent in response to the determination. An indication that the server authenticated the client device is received in response to the request, and the network address is assigned to the client device in response to the indication.

### RELATED APPLICATIONS

This application claims priority under 35 U.S.C. 119(e) to U.S. Provisional Patent Application No. 61/941,106, entitled DHCP Server Enhancement filed Feb. 18, 2014, the contents of which are incorporated herein by reference in their entirety.

### TECHNICAL FIELD

The present disclosure relates to computerized systems and methods for assigning a network address to an unknown client device, and more generally, to network access technologies. By way of example, and without limitation, the present disclosure relates to computerized systems and methods for receiving a request for a network address, and for assigning the network address to an unknown client device in response to the request.

### BACKGROUND

The use of electronic devices to access content over networks has grown significantly over the years. People can now interact with content over networks using a variety of electronic devices. Moreover, people take their electronic devices with them, and access content using different networks at different locations. As a result, electronic devices are often connecting or disconnecting from networks based on changes in location, power state, usage, and more. It is therefore important that networks, such as packet-switched networks, appropriately distribute network configuration parameters, such as network addresses, to electronic devices.

Dynamic Host Configuration Protocol (DHCP) is a network protocol used on Internet Protocol (IP) networks for dynamically distributing network configuration parameters, such as IP addresses, to electronic devices. DHCP allows electronic devices to automatically request network parameters and IP addresses from a DHCP server, and allows the DHCP server to automatically assign the parameters and addresses, thus reducing the need for manual network configuration.

DHCP servers may allocate IP addresses in three different ways. A first method of allocating IP addresses may include dynamic allocation. With dynamic allocation, a network administrator may reserve a range of IP addresses for DHCP. Electronic devices may request IP addresses from the DHCP server, and the DHCP server may allocate and reclaim IP addresses as electronic devices connect and disconnect from the network. A second method of allocating IP addresses may include automatic allocation. With automatic allocation, a DHCP server may permanently assign an IP address to a requesting electronic device from a range of IP addresses defined by a network administrator. The DHCP server may maintain a table of past IP address assignments, so that it may continue to assign the same IP address to an electronic device. A third method of allocating IP addresses may include static allocation. With static allocation, a DHCP server may allocate an IP address based on a preconfigured mapping to an electronic device.

DHCP servers may service networks of varying scales. In small networks, a DHCP server may only need to service a few electronic devices. Large networks, by contrast, may include many network links, and may rely on DHCP relay agents to relay messages between hundreds, or even thousands, of electronic devices and a DHCP server. A number of messages have to be sent between an electronic device and a DHCP server in order for the electronic device to receive an IP address. Unfortunately, DHCP servers can lose information about electronic devices that have been assigned IP addresses, such as when a DHCP server fails. These electronic devices may have to request IP addresses all over again, which can create a heavy workload for the DHCP server, and long delays in receiving IP addresses for the electronic devices.

### SUMMARY

Embodiments of the present disclosure relate to computerized systems and methods for assigning a network address to an unknown client device. In addition, embodiments of the present disclosure relate to receiving a request for a network address, and for assigning the network address to an unknown client device in response to the request.

In accordance with certain embodiments of the present disclosure, computerized systems and methods are provided that receive a message requesting assignment of a network address to a client device, and determine that identification information for the client device is not stored in a storage device. Once the determination has been made, the computerized systems and methods may cause a request for authentication of the client device to be sent to a server. The computerized systems and methods may then receive an indication that the server authenticated the client device in response to the request, and may assign the network address to the client device in response to the indication.

In accordance with some embodiments, there is provided a computer-implemented method for assigning an IP address to a client device through an authentication process without needing to receive a DHCP discover message to trigger the authentication process. The method comprises receiving a DHCP request message requesting assignment of an IP address to the client device, and determining, by one or more processors in response to the DHCP request message, that identification information for the client device is not stored in a storage device. The method also comprises causing a request for authentication of the client device to be sent to a server in response to the determination. The method further comprises receiving an indication that the server authenticated the client device in response to the request, and assigning the IP address to the client device in response to the indication, whereby the IP address is assigned to the client device through the authentication process without needing to receive a DHCP discover message to trigger the authentication process.

Furthermore, in accordance with some embodiments, there is provided a computer-implemented system for assigning an IP address to a client device through an authentication process without needing to receive a DHCP discover message to trigger the authentication process. The system comprises one or more memory devices that store instructions, and one or more processors. The one or more processors execute the instructions to receive a DHCP request message requesting assignment of an IP address to the client device, and determine, in response to the DHCP request message, that identification information for the client device is not stored in a storage device. The one or more processors also execute the instructions to cause a request for authentication of the client device to be sent to a server in response to the determination. The one or more processors further execute the instructions to receive an indication that the server authenticated the client device in response to the request, and to assign the IP address to the client device in response to the indication, whereby the IP address is assigned to the client device through the authentication process without needing to receive a DHCP discover message to trigger the authentication process.

Additionally, in accordance with some embodiments, there is provided a non-transitory computer-readable medium that stores instructions. The instructions, when executed by one or more processors, cause the one or more processors to perform a method for assigning an IP address to a client device through an authentication process without needing to receive a DHCP discover message to trigger the authentication process. The method comprises receiving a DHCP request message requesting assignment of an IP address to the client device, and determining, in response to the DHCP request message, that identification information for the client device is not stored in a storage device. The method also comprises causing a request for authentication of the client device to be sent to a server in response to the determination. The method further comprises receiving an indication that the server authenticated the client device in response to the request, and assigning the IP address to the client device in response to the indication, whereby the IP address is assigned to the client device through the authentication process without needing to receive a DHCP discover message to trigger the authentication process.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute part of this specification, and together with the description, illustrate and serve to explain the principles of various example embodiments.

FIG. 1 illustrates a diagram of example messages exchanged over time in assigning an IP address in a DHCP environment, in accordance with some embodiments.

FIG. 2 illustrates another diagram of example messages exchanged over time in assigning an IP address in a DHCP environment, in accordance with some embodiments.

FIG. 3 illustrates a diagram of an example computing environment, in accordance with some embodiments.

FIG. 4 illustrates a flowchart of an example method for assigning a network address, in accordance with some embodiments.

FIG. 5 illustrates a diagram of example messages transmitted over time in assigning an IP address in a DHCP environment, in accordance with some embodiments.

FIG. 6 illustrates a diagram of an example computer system, in accordance with some embodiments.

### DETAILED DESCRIPTION OF EXAMPLE EMBODIMENTS

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

Embodiments of the present disclosure relate to computerized systems and methods for assigning a network address to an unknown client device. Embodiments of the present disclosure include systems and methods that may receive a request for a network address, and that may assign the network address to an unknown client device in response to the request. For example, a message may be received that includes a request for assignment of a network address to a client device. Based on the message, it may be determined that identification information for the client device is not stored in a storage device. For example, the storage device may store identification information for client devices that are authorized to receive network addresses, or which have previously been assigned network addresses. If a message is received from a client device for which identification information is not stored, a request for authentication of the client device may be sent to a server. The server may contain information about whether the client device is authorized to receive a network address. If the server determines that the client device is authorized to receive a network address, an indication may be received that the server has authenticated the client device. Based on this indication the requested network address may be assigned to the client device.

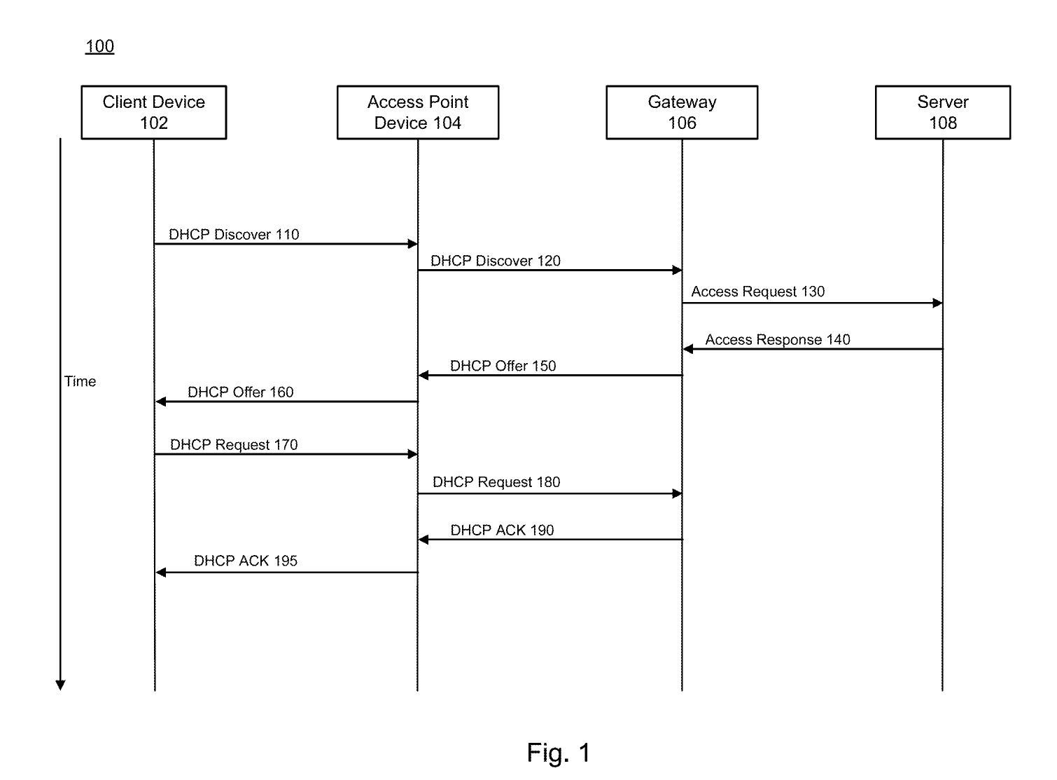

FIG. 1 illustrates a diagram 100 of example messages transmitted over time in assigning an IP address in a DHCP environment. FIG. 1 includes a client device 102, an access point device 104, a gateway 106 and a server 108. When a client device 102 wishes to connect to an Internet network, it sends a request that an IP address be assigned by a DHCP server by sending out a DHCP discover message 110. One or more access point devices 104 may receive the DHCP discover message 110, and may relay the DHCP discover message 110 as DHCP discover message 120 to a gateway 106. The gateway 106 may then send an access request message 130 to a server 108, such as an authentication, authorization, and accounting (AAA) server. The server 108 may then determine whether the client device 102 is authorized to receive the IP address. The server 108 may make this determination based on, for example, a media access control (MAC) address of the client device 102, a subnet address from which the DHCP discover message 120 was received, or other information. The server 108 may then send an access response message 140 to the gateway 106 indicating whether the client device 102 is authorized to receive an IP address. If the client device 102 is authorized to receive an IP address, the gateway 106 may send a DHCP offer message 150 to the client device 102. The DHCP offer message 150 may include an offer of a particular IP address, such as 192.168.1.3, for a particular period of time, such as one hour. The particular period of time may be referred to as a “lease” period during which the IP address is valid. One or more access point devices 104 may relay DHCP offer message 150 to the client device 102 as DHCP offer message 160. If the client device 102 accepts the offer, it may send a DHCP request message 170 indicating that it accepts the particular IP address (e.g., 192.168.1.3) for the particular period of time, (e.g., one hour). One or more access point devices 104 may relay DHCP request message 170 as DHCP request message 180 to the gateway 106. The gateway 106 may then confirm that the IP address (e.g., 192.168.1.3) has been allocated to the client device 102 by sending an acknowledgement message (e.g., DHCP ACK message 190). One or more access point devices 104 may relay ACK message 190 as ACK message 195 to the client device 102. Once the ACK message has been received by the client device 102, the client device 102 may use the IP address. The client device 102 may maintain its IP address by sending DHCP request messages to the gateway 106 to renew its lease on the IP address, and the gateway 106 may confirm that the IP address is renewed by sending ACK messages in response to the DHCP request messages.

One or more advantages may be achieved by assigning network addresses, such as IP addresses, dynamically, such as with DHCP. For example, dynamic assignment of network addresses can reduce the need for a network administrator or user to configure the network addresses manually. This can allow a server, such as a DHCP server, to automatically manage assignment of network addresses on very large networks. However, when a gateway loses information about a client device, such as the client device 102 in FIG. 1, all of the steps involved in assigning an IP address, such as the steps in FIG. 1, may again need to be performed for the client device to receive an IP address. A DHCP server may lose information about a client device for any number of reasons. For example, an idle timeout in the gateway may be set to a period of time that is less than the lease time. If the client device is idle for the period of time, the information about the client device may be deleted from the DHCP server, even though the client device's DHCP lease is still active. As another example, a network administrator may initiate a procedure, such as through a command line interface (CLI) or AAA server, that causes information about a client device to be deleted while the client device's DHCP lease is still valid. As still another example, the DHCP server may be restarted, which may cause it to lose information about a client device, or even information about all of the client devices.

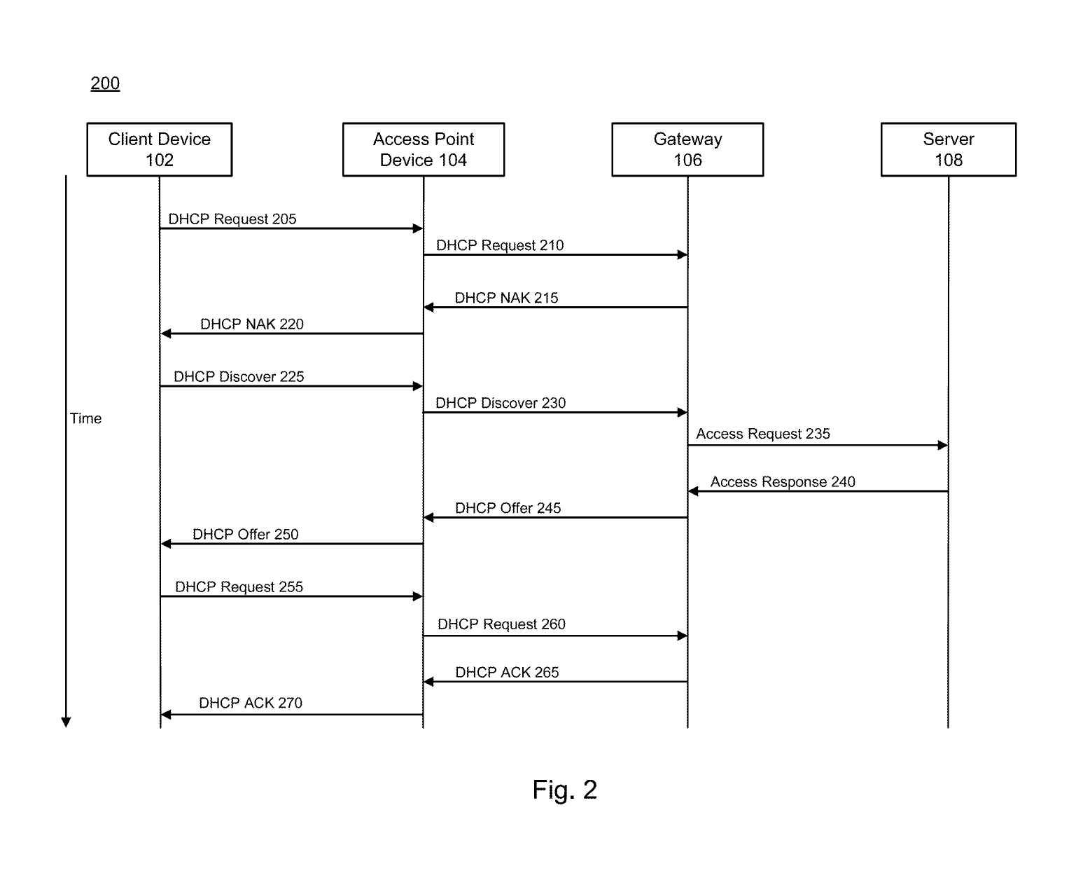

FIG. 2 illustrates a diagram 200 of example messages transmitted over time in assigning an IP address in a DHCP environment when information about a client device is lost. FIG. 2 includes a client device 102, an access point device 104, a gateway 106 and a server 108. The client device 102 may send a DHCP request 205 to a gateway 106 to, for example, renew its lease on the IP address. One or more access point devices 104 may relay the DHCP request 205 as DHCP request 210 to the gateway 106. The gateway 106 may then check to see whether information about the client device 102 is stored at the gateway 106. If information about the client device 102 is not stored at the gateway 106 (e.g., the client information has been lost), a DHCP negative-acknowledgement message (e.g., DHCP NAK message 215) may be sent to the client device indicating that the client device 102's request has been denied (e.g., the request to renew the lease has been denied). One or more access point devices 104 may relay DHCP NAK message 215 to the client device 102 as DHCP NAK message 220. Once the client device 102 has received the DHCP NAK message 220, it may have to restart the DHCP process from the beginning to receive an IP address. Accordingly, the client device 102 may send a DHCP discover message 225 requesting an IP address to the gateway 106. One or more access point devices 104 may relay the discover message 225 to the gateway 106 as DHCP discover message 230. The gateway 106 may then send an access request message 235 to a server 108, such as an AAA server, for authentication. The server 108 may send an access response message 240 to the gateway 106 indicating whether the client device 102 is authorized. If access response message 240 indicates that the client device 102 is authorized, the gateway 108 may send a DHCP offer message 245 to the client device 102. One or more access point devices 104 may relay the DHCP offer message 245 to the client device 102 as DHCP offer message 250. If the client device 102 wants the offered IP address, it may send a DHCP request message 255 to the gateway 106. One or more access point devices 104 may relay DHCP request message 255 to the gateway 106 as DHCP request message 260. The gateway 106 may then confirm that the IP address has been assigned to the client device 102 by sending a DHCP ACK message 265. One or more access point devices 104 may relay DHCP ACK message 265 to the client device 102 as DHCP ACK message 270. Once the client device 102 receives DHCP ACK message 270, it may use the IP address.

As can be seen in FIG. 2, a large number of messages may need to be sent between network devices in order to assign an IP address to a client device when a DHCP server lost information about the client device. This can delay the client device from reconnecting to the network. Moreover, in cases where a large amount of client information is lost, such as when a DHCP server is restarted, the loss of this information can place a heavy load on the DHCP server as it attempts to reassign IP addresses to many client devices, such as all of the client devices on the network. Accordingly, what is needed is a solution for reducing the number of messages that need to be exchanged when a DHCP server loses client device information.

Embodiments of the present disclosure can address the limitations associated with DHCP network address assignment. For example, embodiments of the present disclosure provide computerized systems and methods that may receive a message, such as a DHCP request message, requesting assignment (e.g., a lease renewal) of a network address to a client device. In response to the message, a storage device can be checked for information identifying the client device. If identification information for the client device is not stored in the storage device (e.g., the information has been lost), rather than sending a DHCP NAK message to the client device, a request for authentication of the client device may be sent to a server (e.g., an AAA server). The server may then check to see if it can determine if the client device is authorized. The server may then send a response indicating whether the client device is authorized. If the response indicates that the client device is authorized, the network address may be assigned to the client device.

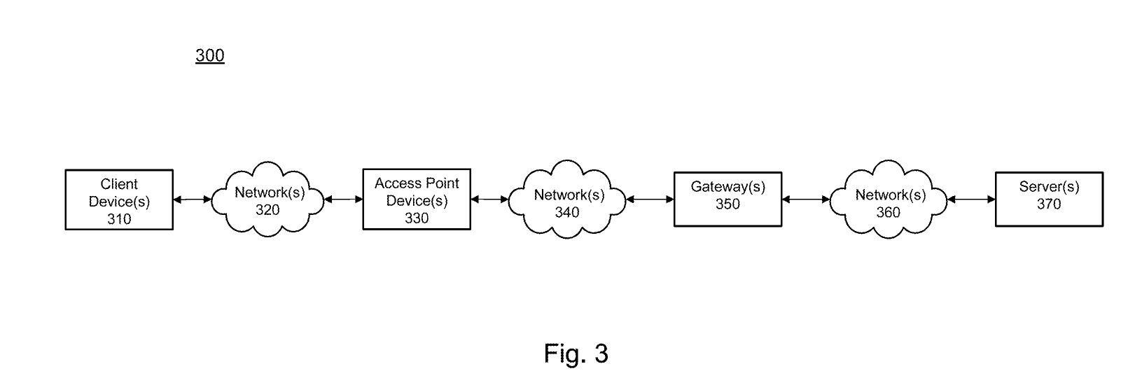

FIG. 3 is a block diagram of an example computing environment 300 for implementing embodiments of the present disclosure. The arrangement and number of components in computing environment 300 is provided for purposes of illustration. Additional arrangements, number of components, and other modifications may be made, consistent with the present disclosure.

As shown in FIG. 3, computing environment 300 may include one or more client devices 310, networks 320, 340, 360, access point devices 330, gateways 350, and servers 370. Client devices 310 may be coupled to access point device(s) 330, gateway(s) 350, and server(s) 370 by one or more networks 320, 340, 360.

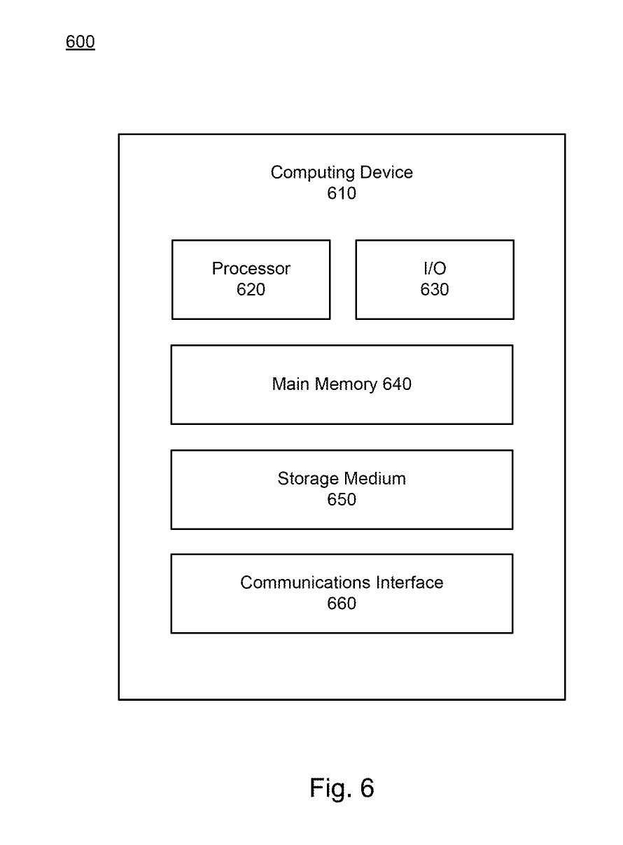

By way of example, a client device 310 could be a personal computer, desktop computer, laptop computer, server, mobile computer, mobile phone, smart phone, tablet computer, netbook, electronic reader, personal digital assistant (PDA), wearable computer, smart watch, gaming device, set-top box, television, personal organizer, portable electronic device, smart appliance, navigation device, and/or other type of computing device. In some embodiments, a client device 310 may be implemented with hardware devices and/or software applications running thereon. A client device 310 may communicate with one or more computer systems (e.g., access point device(s) 330, gateway(s) 350, server(s) 370) over one or more networks 320, 340, 360. A client device 310 may store browser software that enables client device 310 to access resources on a network, such as the Internet, and DHCP client software that enables client device 310 to receive an IP address over DHCP protocol. In some embodiments, one or more of client device(s) 310 may be implemented using a computer system, such as computer system 600 of FIG. 6.

Computing environment 300 may include one or more networks 320. In one embodiment, network(s) 320 may be one or more local networks (e.g., personal area networks (PANs), local area networks (LANs), metropolitan area networks (MANs)), though the disclosure is not so limited. Network(s) 320 may connect client device(s) 310 with one or more access point devices 330, gateways 350, servers 370, and/or other client devices 310. Network(s) 320 may include one or more PANs, LANs, MANs, wide area networks (WANs), or any combination of these networks. Network(s) 320 may include a combination of a variety of different network types, including Ethernet, intranet, twisted-pair, coaxial cable, fiber optic, cellular, satellite, IEEE 802.11, WiFi, terrestrial, Internet, and/or other types of wired or wireless networks.

Client device(s) 310, gateway(s) 350, and/or server(s) 370 may be configured to communicate with one or more access point devices 330 through one or more networks 320. An access point device 330 may be a router or other type of device that may relay messages onto different networks, or different links of a network. In some embodiments, an access point device 330 may control incoming and outgoing network traffic based on pre-established rules. In some embodiments, an access point device may append information, such as data identifying a location or subnet of a network on which the access point device is located, before relaying the message to other network devices. An access point device 330 may by any type of device for relaying network messages, and may exist as software, hardware, or a combination of software and hardware. In some embodiments, one or more access point devices 330 may be implemented using a computer system, such as computer system 600 of FIG. 6.

Computing environment 300 may also include one or more networks 340. In one embodiment, network(s) 340 may be one or more local networks (e.g., personal area networks (PANs), local area networks (LANs), metropolitan area networks (MANs)), though the disclosure is not so limited. Network(s) 340 may connect gateway(s) 350 and/or access point device(s) 330 with one or more client devices 310, servers 370, other access point devices 330, and/or other gateways 350. Network(s) 340 may include one or more PANs, LANs, MANs, wide area networks (WANs), or any combination of these networks. Network(s) 340 may include a combination of a variety of different network types, including Ethernet, intranet, twisted-pair, coaxial cable, fiber optic, cellular, satellite, IEEE 802.11, WiFi, terrestrial, Internet, and/or other types of wired or wireless networks.

Client device(s) 310, access point device(s) 330, and/or server(s) 370 may be configured to communicate with one or more gateways 350 through one or more networks 320, 340, 360. A gateway 350 may control incoming and outgoing network traffic based on pre-established rules, convert messages between different network protocols, store information about client devices 310 on a network, and/or store information about network configuration parameters. In some embodiments, a gateway 350 may be a DHCP server or may include a DHCP server, and may include one or more storage devices (e.g., storage medium(s) 650 of FIG. 6) that store information about IP addresses that have been assigned to client devices 310, lease periods, information identifying client devices 310 (e.g., MAC addresses, device names, user names, domain names, device addresses), and other DHCP information. A gateway 350 may be a standalone computing system or apparatus, or it may be part of a larger system. For example, gateway(s) 350 may represent distributed gateways that are remotely located and communicate over a communication network, or over a dedicated network, such as a LAN. Gateway(s) 350 may include one or more back-end servers for carrying out one or more aspects of the present disclosure.

A gateway 350 may be implemented as a server system comprising a plurality of servers, or a server farm comprising a load balancing system and a plurality of servers. A gateway 350 may be any type of known gateway, such as a wireless access gateway (WAG) or WiFi gateway, and may include any type of known DHCP server. A gateway 350 may exist as software, hardware, or a combination of software and hardware. In some embodiments, one or more gateways 350 may be implemented using a computer system, such as computer system 600 of FIG. 6.

Computing environment 300 may also include one or more networks 360. In one embodiment, network(s) 360 may be one or more local networks (e.g., personal area networks (PANs), local area networks (LANs), metropolitan area networks (MANs)), though the disclosure is not so limited. Network(s) 360 may connect server(s) 370 with one or more client devices gateways 350, access point devices 330, client devices 310, and/or other servers 370. Network(s) 360 may include one or more PANs, LANs, MANs, wide area networks (WANs), or any combination of these networks. Network(s) 360 may include a combination of a variety of different network types, including Ethernet, intranet, twisted-pair, coaxial cable, fiber optic, cellular, satellite, IEEE 802.11, WiFi, terrestrial, Internet, and/or other types of wired or wireless networks.

Client device(s) 310, access point device(s) 330, and/or gateway(s) 350 may be configured to communicate with one or more servers 370. A server 370 may be a network solution for controlling incoming and outgoing network traffic based on pre-established rules, and may store policies provisioned by a network administrator to accept or deny certain devices onto a network. In some embodiments, a server 370 may be an authentication, authorization, and accounting (AAA) server, such as a Remote Authentication Dial In User Service (RADIUS) server or a Terminal Access Controller Access-Control System (TACACS) server. A server 370 may store rules for authenticating client devices 310 onto a network, and/or may store information identifying client devices 310 (e.g., MAC addresses, device names, user names, domain names, device addresses). A server 370 may be a standalone computer system or apparatus, or it may be part of a larger system. For example, server(s) 370 may represent distributed servers that are remotely located and communicate over a communications network, such as a LAN. Server(s) 370 may include one or more back-end servers for carrying out one or more aspects of the present disclosure.

A server 370 may be implemented as a server system comprising a plurality of servers, or a server farm comprising a load balancing system and a plurality of servers. A server 370 may be any type of known server, and may exist as software, hardware, or a combination of software and hardware. In some embodiments, one or more server(s) 370 may be implemented using a computer system, such as computer system 600 of FIG. 6.

Although computing environment 300 of FIG. 3 illustrates separate client access point device(s) 330, gateway(s) 350, and server(s) 370, the disclosure is not so limited. Any of access point device(s) 330, gateway(s) 350, and/or server(s) 370 could be implemented together on the same computer system, such as on computer system 600 of FIG. 6. As one example, access point device(s) 330, gateway(s) 350, and server(s) 370 could all exist on the same computer system, such as on a computer system 600 of FIG. 6. Moreover, in some embodiments, computing environment 300 may not include access point device(s) 330. Rather, messages from a client device 310 may be sent directly to a gateway 350, and messages from a gateway 350 may be sent directly to a client device 310.

Although computing environment 300 of FIG. 3 illustrates separate network(s) 320, 340, 360, the disclosure is not so limited. For example, embodiments of the present disclosure may be implemented in computing environments utilizing only one or two networks, which may include only local network(s) or wide area network(s).

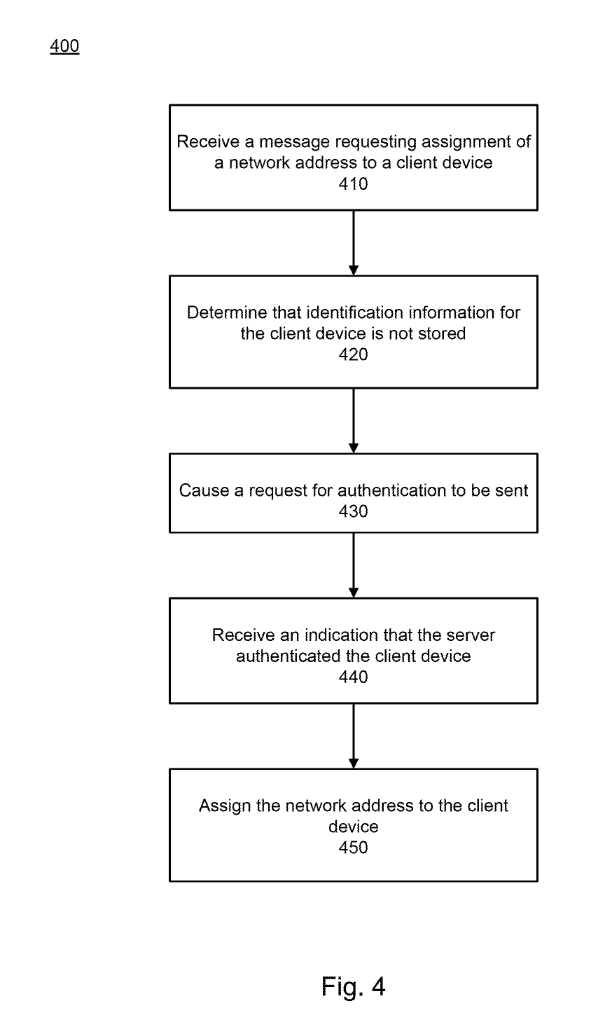

FIG. 4 illustrates a flowchart of an example method 400, consistent with embodiments of the present disclosure. Example method 400 may be implemented in a computing environment (see, e.g., FIG. 3) using one or more computer systems (see, e.g., FIG. 6). In some embodiments, method 400 may be performed by one or more gateways 350, by one or more DHCP servers implemented on one or more gateways 350, or both.

In step 410, a message requesting assignment of a network address to a client device, such as a client device 310, may be received. The message may be, for example, a DHCP request message. The message may be received directly from a client device 310 over network(s) 320, or may be received from an access point device 330 that relayed a DHCP message from a client device 310. The message may specify a particular IP address that the client device is requesting. For example, the IP address may have already been assigned to the client device, and the message may request renewal of a lease on the IP address. As another example, the IP address may be an IP address that was recently associated with the client device. As still another example, the IP address may be an address that was associated with the client device at some point prior to receiving the request, or which the client device desires for some particular reason. The message may also include information identifying the client device, such as a MAC address of the client device, a subnet to which the client device is connected, a hardware address of the client device, a device address of the client device, a user name associated with the client device, a domain name associated with the client device, and/or any other information that identifies the client device. Once the message has been received, method 400 may proceed to step 420.

In step 420, a storage device may be checked to determine whether information identifying the client device is stored. For example, a storage device (e.g., a storage medium 650 of FIG. 6) in a gateway 350, or DHCP server, may include a database or table of information identifying client devices 310 that are assigned IP addresses, that have been assigned IP addresses in the past, and/or that are authorized for assignment of IP addresses. This information may include, for example, MAC addresses of client devices, subnet to which client devices are connected, hardware addresses of client devices, device addresses of client devices, user names associated with client devices, domain names associated with the client devices, and/or any other information that identifies client devices. Whether information identifying the client device is stored may be determined by comparing information in the storage device with information identifying the client device that was received in the message in step 410. If information identifying the client device is stored in the storage device, the IP address may be assigned to the client device if the IP address is available. However, information identifying the client device may not be stored in the storage device. The information may not be in the storage device for any number of reasons. For example, the information may have been lost as a result of an idle timeout, as a result of an administrator-initiated procedure that deleted the information, or as a result of a gateway or DHCP server restart or fault. Alternatively, the storage device may not include information identifying the client device, because the client device has never requested an IP address from the DHCP server, or has not recently requested an IP address from the DHCP server (e.g., the information was deleted as being older than a certain pre-established threshold). If information identifying the client device is not stored in the storage device, the method may proceed to step 430.

In step 430, method 400 may cause a request for authentication to be sent. For example, in response to the determination that information identifying the client device is not stored in the storage device in step 420, method 400 may cause a request for authentication to be sent to a server 370. The request for authentication may be sent, for example, to an AAA server, such as a RADIUS server, and may include a RADIUS access request. The request may be a message including information that was extracted from the message received in step 410, such as information identifying the client device. When the request for authentication is sent, the request for assignment of the network address (e.g., the DHCP request message) received in step 410 may be cached. The server may receive the request, and compare the information in the request with information stored in the server to determine whether the client device is authorized for assignment of the IP address. The server may then send a message responding to the authentication request indicating whether the client device is authorized. The response message may include, for example, a RADIUS access response message. Once the response message has been received, method 400 may proceed to step 440.

In step 440, the response message may be received. If the response message indicates that the client device is not authorized for assignment of the IP address, a NAK message may be sent to the client device indicating that the client device has not been assigned the IP address. If the response message indicates that the client device is authorized for assignment of the IP address, method 400 may proceed to step 450.

In step 450, the IP address may be assigned to the client device. In some embodiments, the IP address may only be assigned to the client device if the requested IP address is available, and/or if the requested IP address is on one of the subnets configured for dynamic allocation. In some embodiments, method 400 may store information indicating that the IP address has been assigned to the client device in the storage device in step 450. Once the IP address has been assigned to the client device, a message, such as a DHCP ACK message, may be sent to the client device confirming that the client device has been assigned the IP address. The message may also include a lease period indicating a time period during which the IP address will be assigned to the client device. Once the client device receives the confirmation message, the client device may begin using the IP address.

The above description of method 400 describes that the method may determine whether the requested IP address is available in step 450. However, the disclosure is not so limited. Method 400 may, for example, determine whether the requested IP address is available in any of steps 410, 420, 430, or 440. If it is determined that the requested IP address is not available in step 410, for example, a NAK message could be sent to the client device, and method 400 would not have to proceed through steps 420, 430, 440, and/or 450. Similarly, the above description of method 400 describes determining whether the requested IP address is on one of the subnets configured for dynamic allocation in step 450. However, method 400 may determine whether the requested IP address is on one of the subnets configured for dynamic allocation in any of steps 410, 420, 430, or 440. If it is determined that the requested IP address is not on one of the subnets configured for dynamic allocation in step 410, for example, a NAK message could be sent to the client device, and method 400 would not have to proceed through steps 420, 430, 440, and/or 450.

In embodiments where the DHCP server is a separate process included in gateway 350, or is a separate server connected to gateway 350 over a network (e.g., one of networks 320, 340, 360), method 400 may include caching DHCP protocol messages and forwarding them to the DHCP server only after a certain step of method 400 has been satisfied. For example, in step 410, the message requesting assignment of an IP address may be a DHCP request message. A gateway receiving this message may cache the message until the gateway has received a message (e.g, from a RADIUS server) indicating that the client device is authenticated. Once RADIUS authentication has succeeded, the gateway may forward the DHCP request message to the DHCP server, so that the IP address may be assigned to the client device. In doing so, the gateway may move the client device to a DHCP REQUEST state in the DHCP server. In some embodiments, the DHCP server may check whether the IP address requested by the client device is available for assignment and/or whether the IP address requested by the client device is on a subnet configured for dynamic IP address allocation prior to assigning the IP address to the client device. Once the IP address has been assigned to the client device, the gateway may receive a DHCP ACK message from the DHCP server, and may forward the DHCP ACK message to the client device.

A gateway 350 performing method 400 may include an ability to handle certain error cases that may arise in performing the method. For example, a DHCP request message may be received by the gateway from a client device when a DHCP request message from the client device is already cached at the gateway awaiting RADIUS authentication. In such a scenario, the gateway may replace the cached DHCP request message with the DHCP request message that was more recently received by the gateway, and may keep a DHCP state for the client device at the DHCP server at a REQUEST state. As another example, a DHCP discover message may be received by the gateway from a client device when a DHCP discover message from the client device is already cached at the gateway awaiting a RADIUS authentication. In such a scenario, the gateway may replace the cached DHCP discover message with the DHCP discover message that was more recently received by the gateway, and may move a DHCP state for the client device at the DHCP server to a DISCOVER state. As still another example, if an IP address requested in a DHCP request message does not match a subnet configured for dynamic IP address allocation, or is not available for assignment, the DHCP server can send a DHCP NAK message to the gateway, and a DHCP state for the client device at the DHCP server can be moved to a NONE state. As a further example, if a DHCP request message is received when a DHCP state in a DHCP server is at a NONE state, the state can be moved to a REQUEST state.

A gateway 350 performing method 400 may also include registration timeout periods to delete information identifying client devices from a cache or storage device. A time period for the registration timeout may be preset (e.g., five minutes) or configurable by a network administrator. In some embodiments, a timer may be started in the gateway when a DHCP NAK message has been sent by the gateway to the client device. The timer may be cancelled if any DHCP protocol message is received by the gateway for the client device. If no DHCP protocol message is received by the gateway for the client device before the time of the timer equals the registration timeout time period, the information identifying the client device may be deleted from a cache or storage device at the gateway.

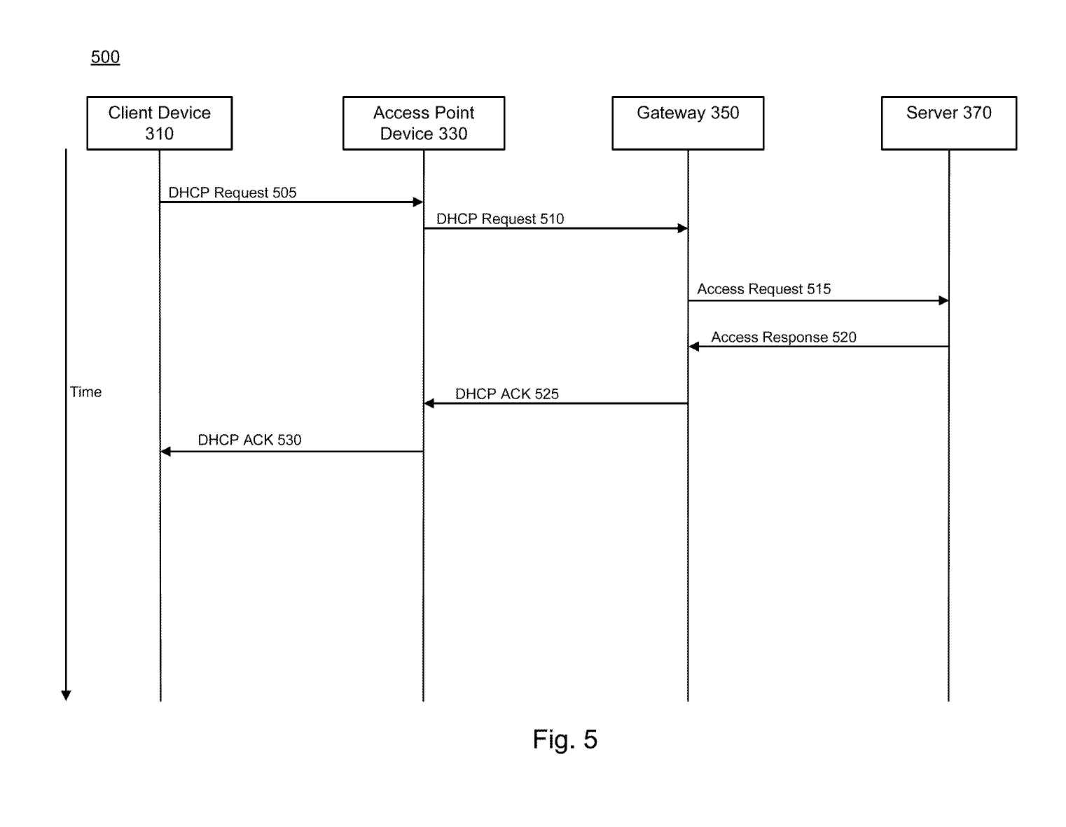

FIG. 5 illustrates a diagram 500 of example messages transmitted over time in assigning an IP address in a DHCP environment, consistent with embodiments of the present disclosure. A client device 310 may send a DHCP request message 505 requesting assignment of an IP address from a DHCP server. In some embodiments, the DHCP request message 505 may be received by an access point device 330, which may relay the DHCP request message 505 as DHCP request message 510 to gateway 350. DHCP request message 510 may be the same as DHCP request message 505, or may include additional information (e.g., identifying a subnet or identifying the access point device) added to DHCP request message 505 by access point device 330. After receiving DHCP request message 510, gateway 350 may send an access request message 515 to a server 370 (e.g., an AAA server, such as a RADIUS server). The access request message may request authentication of the client device. Server 370 may determine whether the client device is authorized to receive the IP address, and may send an indication of whether the client device is authorized to receive the IP address in access response message 520. Gateway 350 may receive access response message 520 from server 370, and may identify whether server 370 authenticated the client device. If access response message 520 indicates that the client device is authorized to receive the IP address, gateway 350 may send a DHCP ACK message 525. In some embodiments, the DHCP ACK message 525 may be received by an access point device, 330, which may relay the DHCP ACK message 525 to the client device as DHCP ACK message 530. DHCP ACK message 530 may be the same as DHCP ACK message 525, or may include additional information added to DHCP message 525 by access point device 330. The client device may then receive DHCP ACK message 530 from the access point device 330.

Although FIG. 5 illustrates messages being exchanged with access point devices 330, the disclosure is not so limited. In some embodiments, DHCP protocol messages may be exchanged directly between client device(s) 310 and gateway(s) 350, without having to be relayed by access point device(s) 330.

As can seen from FIG. 5, the embodiments disclosed herein provide a technique for assigning IP addresses that requires fewer messages to be exchanged than the techniques illustrated in FIG. 1 or 2. For example, using the embodiments disclosed herein, IP addresses may be assigned to client devices without needing to receive a DHCP discover message and/or without having to send a DHCP offer message. Accordingly, when information identifying a client device is lost at a gateway, an IP address may be more quickly and efficiently assigned to the client device than with the techniques illustrated in FIG. 1 or 2.

FIG. 6 is a block diagram illustrating an example computer system 600 that may be used for implementing embodiments consistent with the present disclosure, including the example systems and methods described herein. Computer system 600 may include one or more computing devices 610. Computer system 600 may be used to implement client device(s) 310, access point device(s) 330, gateway(s) 350, server(s) 370, and/or any DHCP servers external to gateway(s) 350. The arrangement and number of components in computer system 600 is provided for purposes of illustration. Additional arrangements, number of components, or other modifications may be made, consistent with the present disclosure.

As shown in FIG. 6, a computing device 610 may include one or more processors 620 for executing instructions. Processors suitable for the execution of instructions may include, by way of example, both general and special purpose microprocessors, and any one or more processors of any kind of digital computer. A computing device 610 may also include one or more input/output (I/O) devices 630. By way of example, I/O devices 630 may include keys, buttons, mice, joysticks, styluses, etc. Keys and/or buttons may be physical and/or virtual (e.g., provided on a touch screen interface). A computing device 610 may also be connected to one or more displays (not shown) via I/O 630. A display may be implemented using one or more display panels, which may include, for example, one or more cathode ray tube (CRT) displays, liquid crystal displays (LCDs), plasma displays, light emitting diode (LED) displays, touch screen type displays, projector displays (e.g., images projected on a screen or surface, holographic images, etc.), organic light emitted diode (OLED) displays, field emission displays (FEDs), active matrix displays, vacuum fluorescent (VFR) displays, 3-dimensional (3-D) displays, electronic paper (e-ink) displays, or any combination of the above types of displays.

A computing device 610 may include one or more storage devices configured to store data and/or software instructions used by processor(s) 620 to perform operations consistent with disclosed embodiments. For example, a computing device 610 may include main memory 640 configured to store one or more software programs that, when executed by processor(s) 620, cause processor(s) 620 to perform functions or operations consistent with disclosed embodiments.

By way of example, main memory 640 may include NOR and/or NAND flash memory devices, read only memory (ROM) devices, random access memory (RAM) devices, etc. A computing device 610 may also include one or more storage mediums 650. By way of example, storage medium(s) 650 may include hard drives, solid state drives, tape drives, redundant array of independent disks (RAID) arrays, etc. Although FIG. 6 illustrates only one main memory 640 and one storage medium 650, a computing device 610 may include any number of main memories 640 and storage mediums 650. Further, although FIG. 6 illustrates main memory 640 and storage medium 650 as part of computing device 610, main memory 640 and/or storage medium 650 may be located remotely and computing device 610 may be able to access main memory 640 and/or storage medium 650 via network(s) 320, 340, 360.

Storage medium(s) 650 may be configured to store data, and may store data received from one or more of client device(s) 310, access point device(s) 330, gateway(s) 350, and/or server(s) 370. The data may take or represent various content or information forms, such as documents, tables, lists, IP addresses, client device information, security information, software applications, files, and any other type of information and/or content which may be used in network applications, or any combination thereof.

A computing device 610 may further include one or more communication interfaces 660. Communication interface(s) 660 may allow software and/or data to be transferred between client device(s) 310, access point device(s) 330, gateway(s) 350, and server(s) 370. Examples of communications interface 660 may include a modem, network interface card (e.g., Ethernet card), communications port, personal computer memory card international association (PCMCIA) slots and cards, antennas, etc. Communications interface(s) 660 may transfer software and/or data in the form of signals, which may be electronic, electromagnetic, optical, and/or other types of signals. The signals may be provided to/from communication interface(s) 660 via a communications path (e.g., network(s) 320, 340, 360), which may be implemented using wired, wireless, cable, fiber optic, radio frequency (RF), and/or other communications channels.

The disclosed embodiments are not limited to separate programs or computers configured to perform dedicated tasks. For example, a gateway 350 may include a computing device 610 that includes a main memory 640 that stores a single program or multiple programs and may additionally execute one or more programs located remotely from gateway 350. Similarly, a client device 310, access point device 330, and/or server 370 may execute one or more remotely stored programs instead of, or in addition to, programs stored on these devices. In some examples, a gateway 350 may be capable of accessing separate server(s), gateways, DHCP servers, and/or computing devices that generate, maintain, and provide network configuration information and/or client device information.

Although the description above has described the use of gateway(s) 350 in the context of assigning IP addresses to client devices, the disclosure is not so limited. One of skill in the art would recognize that a gateway 350 implementing the features and embodiments of the present disclosure may assign other types of network addresses based on requests from client devices, in a similar manner to that disclosed herein. That is, the features and embodiments disclosed herein are not limited in application to assigning IP addresses.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computer-implemented method for assigning an Internet Protocol (IP) address to a client device through an authentication process without needing to receive a dynamic host configuration protocol (DHCP) discover message to trigger the authentication process, comprising:
receiving, by a computing device including a memory and a processor configured to execute instructions stored in the memory, a DHCP request message requesting assignment of an IP address to the client device;
determining, by the computing device, in response to the DHCP request message, that identification information for the client device is not stored in a storage device;
causing, by the computing device, a request for authentication of the client device to be sent to a server in response to the determination;
receiving, by the computing device, an indication that the server authenticated the client device in response to the request; and
assigning, by the computing device, the IP address to the client device in response to the indication, whereby the IP address is assigned to the client device through the authentication process without needing to receive a DHCP discover message to trigger the authentication process.

2. The method of claim 1, wherein the computing device is a gateway, and the gateway includes the storage device.

3. The method of claim 1, wherein the step of assigning the IP address to the client device includes sending a DHCP acknowledgement (ACK) message to the client device confirming that the IP address has been assigned to the client device.

4. The method of claim 1, further comprising the following operations conducted prior to the step of receiving the DHCP request message:
storing the identification information for the client device in the storage device; and
erasing the identification information from the storage device.

5. The method of claim 1, wherein the server is a Remote Authentication Dial In User Service (RADIUS) server.

6. The method of claim 1, wherein the DHCP request message includes client device identification information, and the computing device determines that identification information for the client device is not stored in the storage device by comparing the client device identification information with identification information stored in the storage device.

7. The method of claim 1, wherein the request for authentication includes client device identification information extracted from the DHCP request message, and the server authenticates the client device by determining that the extracted client device identification information matches with client information stored in the server.

8. The method of claim 1, further comprising assigning the IP address to the client device upon determining that the IP address is available and that the IP address is on a subnet configured for dynamic address allocation.

9. The method of claim 1, wherein the DHCP request message includes a request for a renewal of a lease period for the IP address.

10. The method of claim 1, further comprising caching, by the computing device, the DHCP request message until the indication that the server authenticated the client device is received.

11. A computer-implemented system for assigning an Internet Protocol (IP) address to a client device through an authentication process without needing to receive a dynamic host configuration protocol (DHCP) discover message to trigger the authentication process, comprising:
one or more memory devices that store instructions; and
one or more processors that execute the instructions to:
receive a DHCP request message requesting assignment of an IP address to the client device;
determine, in response to the DHCP request message, that identification information for the client device is not stored in a storage device;
cause a request for authentication of the client device to be sent to a server in response to the determination;
receive an indication that the server authenticated the client device in response to the request; and
assign the IP address to the client device in response to the indication, whereby the IP address is assigned to the client device through the authentication process without needing to receive a DHCP discover message to trigger the authentication process.

12. The system of claim 1, wherein the system is a gateway and the gateway includes the storage device.

13. The system of claim 1, wherein the step of assigning the IP address to the client device includes sending a DHCP acknowledgement (ACK) message to the client device confirming that the IP address has been assigned to the client device.

14. The system of claim 1, the one or more processors further executing the instructions to:
store the identification information for the client device in the storage device prior to the step of receiving the DHCP request message; and
erase the identification information for the client device from the storage device prior to the step of receiving the DHCP request message.

15. The system of claim 1, wherein the server is a Remote Authentication Dial In User Service (RADIUS) server.

16. The system of claim 1, wherein the DHCP request message includes client device identification information, and the one or more processors further execute the instructions to determine that identification information for the client device is not stored in the storage device by comparing the client device identification information with identification information stored in the storage device.

17. The system of claim 1, wherein the request for authentication includes client device identification information extracted from the DHCP request message, and the server authenticates the client device by determining that the extracted client device identification information matches with client information stored in the server.

18. The system of claim 1, wherein the one or more processors further execute the instructions to assign the IP address to the client device upon determining that the IP address is available and that the IP address is on a subnet configured for dynamic address allocation.

19. The system of claim 1, wherein the DHCP request message includes a request for a renewal of a lease period for the IP address.

20. A non-transitory computer-readable medium storing instructions that, when executed by one or more processors, cause the one or more processors to perform a method for assigning an Internet Protocol (IP) address to a client device through an authentication process without needing to receive a dynamic host configuration protocol (DHCP) discover message to trigger the authentication process, the method comprising:
receiving a DHCP request message requesting assignment of an IP address to the client device;
determining, in response to the DHCP request message, that identification information for the client device is not stored in a storage device;
causing a request for authentication of the client device to be sent to a server in response to the determination;
receiving an indication that the server authenticated the client device in response to the request; and
assigning the IP address to the client device in response to the indication, whereby the IP address is assigned to the client device through the authentication process without needing to receive a DHCP discover message to trigger the authentication process.
